(19) United States
(12) Patent Application Publication
(10) Pub. No.: US 2016/0201855 A1
(43) Pub. Date: Jul. 14, 2016

(54) SORPTION STORE WITH IMPROVED HEAT TRANSFER

(71) Applicants: BASF SE, Ludwigshafen (DE); BASF CHINA COMPANY LIMITED, Pudong, Shanghai (CN)

(72) Inventors: Matthias WEICKERT, Ludwigshafen (DE); Stefan MARX, Dirmstein (DE); Ulrich MÜLLER, Neustadt (DE); Peter RENZE, Mannheim (DE)

(21) Appl. No.: 14/911,884

(22) PCT Filed: Aug. 11, 2014
(86) PCT No.: PCT/IB2014/063850

§ 371 Date: Feb. 12, 2016

(30) Foreign Application Priority Data
Aug. 15, 2013 (EP) 13180520.2

(51) Int. Cl. F17C 11/00; F17C 5/02

(52) U.S. Cl. CPC F17C 11/007; F17C 5/02; F17C 2270/01; F17C 2260/023; F17C 2221/033

(57) ABSTRACT

Sorption store (10) particularly for storing an adsorbed natural gas, said sorption store (10) containing at least one adsorbent medium (40), wherein said sorption store (10) is equipped with an external passive cooling (72).

The present invention relates to a sorption store, particularly for storing adsorbed natural gas (ANG) having an improved heat transfer capability.

Owing to the increasing scarcity of oil resources, research is increasingly being made to unconventional fuels such as methane, ethanol or hydrogen for operating an internal combustion engine or a fuel cell. For this purpose, vehicles comprise a storage vessel for keeping a stock of the fuel. For the storage of gas in stationary and mobile applications, the gas is stored in pressure vessels, often referred to as compressed natural gas (CNG) technique or in sorption stores, often referred to as adsorbed natural gas (ANG) technique. Sorption stores are also known as ANG tanks.

ANG has the potential to replace compressed natural gas CNG in mobile storage applications such as in vehicles. Although a substantial research effort has been devoted to ANG, very few studies evaluate the impact of heat of adsorptions on system performance. In turn, in ANG-applications a micro powder solid, such as activated carbon, is packed in a vessel to increase the storage density, enabling lower pressure operation with the same capacity. Adsorption is an exothermic process. Any adsorption or desorption is accompanied by a temperature change in an ANG-storage system. The heat of adsorption has a detrimental effect on performance during both filling- and discharge cycles. A temperature increase as high as 80° C. can occur during the filling cycle. A filling cycle normally will be performed in a fuel station, at least for mobile applications, where the released adsorption heat can be removed. Contrary to the filling cycle, the rate of discharge is dictated by the energy demand of the application. The filling time cannot be widely varied to moderate the impact of cooling during the use of ANG storage vessels.

Sorption stores comprise in particular adsorbent media having a large internal surface area on which the gas is adsorbed. The gas is stored by the adsorption on the adsorbent medium, in the cavities between the individual particles of the adsorbent medium and in parts of the vessel, which are not filled with adsorbent medium. The filled sorption store can be operated pressurized and non-pressurized. The selection of a suitable vessel depends on the applied maximum pressure. The higher the storage pressure, the more gas can be stored per volume.

Adsorption describes the attachment of atoms or molecules of a gaseous or liquid fluid onto the surface of a solid material, which is referred to as adsorbent medium for the purpose of the present invention. Terms like adsorbent, adsorber and adsorbent medium are equally known for the denomination of the said solid material. The adsorption capacity of the adsorbent media, defined by the ratio of the mass of the adsorbed gas or liquid to the mass of the adsorbent medium, strongly depends on temperature and is reduced with increasing temperature. In the aim of a maximal exploitation of the storage space, the temperature profile established in the adsorbent media during the filling procedure has to be taken into consideration. Furthermore, an efficient adsorption allows a reduced filling time as the same amount of gas can be stored in a shorter time period. Hence, the maximum amount of stored gas can be increased when the available filling time is limited. During filling the sorption store with gas two sources are relevant for a temperature increase in the vessel. These are the heat due to the compression of the gas and the heat liberated as a result of the exothermic adsorption. The generated heat directly depends on the amount of adsorbed gas. The more gas is adsorbed on the adsorbent medium, the more heat is liberated. And with increasing adsorbed amount of gas on the adsorbent medium, the adsorption rate, defined as amount of gas adsorbed per unit of time, is reduced.

Besides, desorption is an endothermic process and heat has to be supplied when gas is taken from the store. Heat management is therefore of great importance when sorption stores are used.

A crucial aspect for sorption stores in mobile applications is the limited space available for example on vehicles. Therefore, a high energy density in the sorption store is pursued in order to maximize the range a vehicle can cover with only one fill-up.

### PRIOR ART

From the publication K. A. Rahman et al., Applied Thermal Engineering 31 (2011) 1630-1639 an ANG-storage assembly is known. According to this publication, a storage assembly comprises an adsorbent which is packed in between fin gaps. Stainless steel woven mesh is wrapped around the finned-tube adsorbent bed to hold the adsorbent particles and also to prevent fly-out of the adsorbent particles during evacuation. The tubes pass through the fins and are arranged in two circles with uniform spacing. The tubes of the inner circle are connected with the nearest tubes of the outer circle with U-bends. The outer ends of the tubes are connected in separate circular headers. Two pipes are brazed with the circular headers for the coolants, such as water, arranged to flow through the metal tubes from the inner tubes to the outer tubes, respectively. The fin and tube materials are considered as copper and it should be noted that an electroplating of a Ni-Cr is necessary for the copper fins and tubes to be used in the adsorbent bed. The ANG-storage assembly according to this publication is arranged substantially in vertical direction.

US 2005/0178463 A1 is related to a control method for high-pressure hydrogen vehicle fueling station dispensers. According to this publication, a method for quick filling a vehicle hydrogen storage vessel with hydrogen is disclosed, the key component of which is an algorithm used to control the fill process, which interacts with the hydrogen dispensing apparatus to determine the vehicle hydrogen storage vessel capacity.

EP 1 442 250 B1 is related to a method for absorbing vapors and gases from pressure vessels. For absorbing vapors and gases by controlling overpressure in storage tanks for liquids is disclosed according to which the vapor/gas is led to an absorption device placed in a submerged position in a liquid of a tank near the bottom of the tank. Gas is absorbed into the tank liquid that surrounds the absorption device and circulates through it or is supplied from an external source. Absorbed vapor/gas is returned from the absorption device to the gas zone at the top of the tank or led out of the tank. According to EP 1 442 250 B1, the absorption medium is cooled with a coolant element.

DE 197 35 007 C1 discloses an apparatus for storing and transfer of heat. According to this application, liquids/gas containing vessels are positioned particularly in vertical standing arrangement.

EP 0 854 749 B1 is related to a fluid storage and delivery system comprising a high work capacity physical sorbent. According to EP 0 854 749 B1, a storage and dispensing system is disclosed for the selective dispensing of fluids from a vessel or storage container in which the fluid component(s) are held in sorptive relationship to a solid sorbent medium, and are desorptively released from the sorbent medium in a dispensing operation.

U.S. Pat. No. 8,282,023 B2 is related to a fluid storage and dispensing system and a fluid supply process comprising the same. In this publication various arrangements of fluid storage and dispensing systems are disclosed, involving permutations of the physical sorbent-containing fluid storage and dispensing vessels and internal regulator-equipped fluid storage and dispensing vessels. The systems and processes are applicable to a wide variety of end-use applications, including storage and dispensing of fluids with enhanced safety. In a specific end-use application, reagent gas is dispensed to a semiconductor manufacturing facility from a large-scale, fixedly positioned fluid storage and dispensing vessel containing physical sorbent holding gas at atmospheric pressure, with such vessel being refillable from a safe gas source of refillable gas.

### SUMMARY OF THE INVENTION

In view of the disadvantages encountered with the solution of the prior art, it is an object of the present invention to improve the heat transfer capability of a sorption store, particularly for an adsorbed natural gas (ANG). Still further, it is an object of the present invention, to minimize filling time of a sorption store with an adsorbed natural gas to be filled to said sorption store and to maximize by means of an intelligent temperature management the gas mass to be stored within at least one adsorbent medium.

For the purposes of the invention, sorption stores are stores which comprise an adsorbent medium having a large surface area in order to adsorb gas and thereby store it. Sorption stores can store gas by both means of adsorption and means of compression of gas. Thus, heat is liberated during filling of the sorption store, while the desorption is activated by introduction of heat.

According to the present invention, an intelligent temperature management for a sorption store is proposed according to which a sorption store, particularly for storing an adsorbed natural gas, said sorption store containing at least one adsorbent medium, particularly in the form of pellets, is equipped with an active, for example a circulating cooling system on the one hand and/or on the other hand, said sorption store comprises an external passive cooling.

According to the present invention, said external passive cooling of said sorption store either mounted in vertical orientation, in horizontal orientation or even in an inclined orientation, is established by a connection of said sorption store walls or parts of those walls to a vehicle or a vehicle body, such as a chassis of the vehicle. By means of the connection of parts or areas of the outer wall, either single walled or double walled, to the vehicle or the vehicle's body, respectively, an improved heat conduction is established, which uses the vehicle or the vehicle body itself as a heat sink, i.e. a metal-body the heat capacity of which is large as compared to the walls or the area of walls of the respective sorption store.

In the further advantageous embodiments of the present invention, said connection of the sorption store to the respective vehicle or vehicle body is a surface contact between said sorption store and said vehicle or vehicle body, particularly if ⅛ up to ⅔ of the entire surface wall of the sorption store is in intimate contact with the vehicle or said vehicle's body, respectively. In case the sorption store according to the present invention is mounted on a vehicle or in a stationary application in a substantially horizontal orientation, it is very advantageous in respect of the passive external cooling via heat conduction to have the upper part of the vehicle or the vehicles body connected to the larger part of the surface wall of said sorption store.

In a filling operation, the temperature of the surface wall of said sorption store can be kept constant to improve the heat transfer and to maximize the capacity of gas loaded by the at least one adsorbent medium, such as MOF, for example A520, Z377 and C300, to give a few examples of suitable metal-organic frameworks.

It is conceivable to have the sorption store's wall either manufactured as a single flat wall or a double wall within which a cooling agent or a cooling fluid may circulate. In case a double wall is used, the sorption store according to the present invention can be equipped with an active circulated cooling system, which establishes a circulation of a coolant through the hollow interior which is defined by the double wall structure of the sorption store. Heat which is generated in the center of the sorption store is transferred very effectively by a circulating active cooling mechanism to the periphery of the at least one adsorbent medium, stored in the form of pellets within the interior of the sorption store. In consequence, the heat is transferred to the walls, which define the periphery of the sorption store according to the present invention and since the circulated cooling agent is present there, the heat, particularly reaction enthalpy, will be removed from the interior of the tank, so that the capability of adsorbing gas is enhanced by an active cooling of the sorption store, particularly the at least one adsorbent medium stored therein. Thus, the mass of gas to be adsorbed by the at least one adsorbent medium is maximized by implementing the present invention.

In the interior of said sorption store, gas currents occur. The driving force is due to gravity differences, which are induced, particularly then when the sorption store according to the present invention is mounted in substantially vertical direction. Still further, an additional gas current system is established within the interior of the sorption store according to the present invention, the driving force of which are density differences of the gas, induced by temperature differences between an upper and a lower part of the sorption store, depending on whether the sorption store according to the present invention is mounted in a substantially vertical orientation or whether the sorption store according to the present invention is mounted in a substantially horizontal or inclined position on a vehicle or a stationary application.

According to the present invention, in the interior of said sorption store, being equipped with at least one adsorbent medium, gas current systems are established. One of said gas current system is driven due to gravity differences particularly in a sorption store which is mounted on a vehicle, a vehicle's body or a stationary application in substantially vertical orientation. A further gas current system is established within the hollow interior of said sorption store, the driving force of which are density differences of the gas to be adsorbed by the at least one adsorbent medium within the sorption store.

The more heat, particularly from an upper part of the sorption store is removed, either by heat conduction, i.e. passive cooling, or by an active cooling, such as a circulating cooling of the surface walls of the sorption store, the more the adsorption capacity of the at least one adsorbent medium stored within the sorption store, such as a metal-organic framework for example, is enhanced. Still further, by a passive and an active cooling according to the present invention, the filling time of the sorption store according to the present invention can be reduced significantly and the mass to be filled to the respective sorption store can be maximized. In consequence, said gas current systems established within the sorption store allow a homogeneous temperature distribution within the sorption store, so that “hot spots” are avoided. “Hot spots” may damage the rigidity of the sorption store with respect to carbon liners, which are mounted on the inside of the sorption stores and which tolerate temperatures to 80° C. only.

According to the present invention, the entire mass of a vehicle or vehicle's body, such as a chassis, may be used as a heat sink to allow transferring the heat caused by a reaction enthalpy to the vehicle's body itself via heat conduction. According to the present invention, both mechanisms of heat transfer convection, i.e. a forced circulation as well as a passive external cooling by means of heat conduction can be used to improve the heat management of a sorption store according to the present invention.

Still further, the present invention is related to a method for reducing the filling time of the sorption store, particularly for an adsorbed natural gas (ANG) by the following method steps:

a) A natural gas to be adsorbed is adsorbed by at least one adsorbent medium within the sorption store,

b) the interior of the sorption store is actively cooled by a cooling system, particularly a circulation system,

c) a passive cooling of the surface wall of the sorption store is established by heat conduction to a heat sink, for example a vehicle or a vehicle's body and

d) a homogeneous temperature distribution is created within the sorption store according to the present invention by inducing at least one gas-eddy-system in the interior, due to gravity and/or density differences of the natural gas to be adsorbed.

Still further, by means of the active and passive cooling mechanisms established within the sorption store according to the present invention, the center of said sorption store is cooled to enhance adsorption capacity of the at least one adsorbent medium in the center. The heat is transported to the periphery, which for instance very effectively can be cooled by means of a double-sided surface wall, defining the sorption tank, in the interior of which a coolant is circulated.

Still further, the filling time of a sorption store to be filled with a natural gas to be adsorbed is improved if the surface temperature of the surface wall of the sorption store is substantially maintained constant upon a filling operation of said sorption store.

### Advantages of the Invention

The present invention allows a homogeneous temperature distribution within a sorption store to be filled with a natural gas to be adsorbed on at least one adsorbent medium, for example a metal-organic framework, such as A520, Z377 and C300 to mention but a few. By means of the gas current systems or the gas-eddy-systems established within the interior of said sorption store, the heat transfer from the center of the sorption store to its periphery is significantly increased. Since the heat, created by the reaction enthalpy of the natural gas when adsorbed by the at least one adsorbent medium, is transported to the periphery of said sorption store and easy to transport from there to a vehicle's chassis or another kind of heat sink.

According to the present invention, the heat transfer mechanisms, the convection established by an active circulating cooling mechanism as well as heat conduction, i.e. said external passive heat transfer mechanism, are combined to remove the heat, which is generated, from the center and the periphery of the sorption store very effectively using a vehicle's mass as a heat sink to cool said sorption store. This, on the one hand, allows that the adsorption capacity of the at least one adsorbent medium is fully used and that the maximum of natural gas is adsorbed by the at least one adsorbent medium present in the interior of said sorption store. This, on the other hand, has the advantageous effect that the filling time of a sorption store according to the present invention is reduced significantly, taking into account that a vehicle, particularly a heavy duty vehicle, such as a truck, which has three or more sorption stores on board, is fueled at a gas station within less than an hour.

### BRIEF DESCRIPTION OF THE DRAWINGS

The present invention is described below by the accompanying drawings:

FIG. 1 shows a single sorption store in vertical direction,

FIG. 2 shows a sorption store according to the present invention with an active cooling system,

FIG. 3 shows a sorption store according to the present invention in a substantially horizontal orientation having double-walled separation elements as well as double-walled walls and a heat exchanger integrated into a circulation circuit,

FIG. 4 shows a double-walled sorption store according to the present invention with a central feeding pipe,

FIG. 5 shows an automotive application of a sorption store, a number of which having a cylindrical geometry are mounted in a vertical orientation on a vehicle, particularly a truck,

FIG. 6 shows the vehicle given in FIG. 5 from the rearward position with horizontally mounted sorption stores and

FIG. 7 shows a vehicle application with a sorption store, which is mounted in a substantially horizontal direction and has an intimate contact to the vehicle or the vehicle's body, respectively.

### PREFERRED EMBODIMENTS

In an embodiment of the invention the stored gas contains hydrocarbons and/or water, and combinations thereof. The stored gas contains preferably gas selected from a group comprising of methane, ethane, butane, hydrogen, propane, propene, ethylene, water and/or methane, and combinations thereof, in particular natural gas. In particular preferred is stored gas which comprises methane as a main component.

Fuels can be stored in the sorption store of the invention and be provided by desorption to an internal combustion engine or a fuel cell for example. Methane is particularly suitable as fuel for internal combustion engines. Fuel cells are preferably operated using methanol or hydrogen.

In a preferred embodiment of the invention the gas adsorbent medium is a porous and/or microporous solid.

For sorption stores according to the present invention, various materials are suitable as adsorbent medium. The adsorbent medium preferable comprises activated charcoals, zeolites, activated aluminia, silica gels, open-pore polymer foams and metal-organic frameworks (MOFs). The adsorbent medium preferably comprises metal-organic frameworks (MOFs).

Zeolites are crystalline aluminosilicates having a microporous framework structure made up of AlO4- and SiO4 tetrahedra. Here, the aluminum and silicon atoms are joined to one another via oxygen atoms. Possible zeolites are zeolite A, zeolite Y, zeolite L, zeolite X, mordenite, ZSM (Zeolites Socony Mobil) 5 or ZSM 11. Suitable activated carbons are, in particular, those having a specific surface area above 500 m² g⁻¹, preferably above 1500 m² g⁻¹, very particularly preferably above 3000 m² g−1. Such an activated carbon can be obtained, for example, under the name Energy to Carbon or MaxSorb.

Metal-organic frameworks (MOF) are known in the prior art and are described, for example, in U.S. Pat. No. 5,648,508, EP-A-0 790 293, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, DE-A-101 11 230, DE-A 10 2005 053430, WO-A 2007/054581, WO-A 2005/049892 and WO-A 2007/023134. The metal-organic frameworks (MOF) mentioned in EP-A-2 230 288 A2 are particularly suitable for sorption stores. Preferred metal-organic frameworks (MOF) are MIL-53, Zn-tBu-isophthalic acid, Al-BDC, MOF 5, MOF-177, MOF-505, MOF-A520, HKUST-1, IRMOF-8, IRMOF-11, Cu-BTC, Al-NDC, Al-AminoBDC, Cu-BDC-TEDA, Zn-BDC-TEDA, Al-BTC, Cu-BTC, Al-NDC, Mg-NDC, Al-fumarate, Zn-2-methylimidazolate, Zn-2-aminoimidazolate, Cu-biphenyldicarboxylate-TEDA, MOF-74, Cu-BPP, Sc-terephthalate. Greater preference is given to MOF-177, MOF-A520, HKUST-1, Sc-terephthalate, Al-BDC and Al-BTC.

Apart from the conventional method of preparing the MOFs, as described, for example, in U.S. Pat. No. 5,648,508, these can also be prepared by an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Particularly suitable materials for the adsorption in sorption stores are the metal-organic framework materials MOF A520, MOF Z377 and MOF C300.

MOF A 520 is based on aluminium fumarate. The specific surface area of a MOF A520, measured by porosimetry or nitrogen adsorption, is typically in the range from 800 m̂2/g to 2000 m̂2/g. The adsorption enthalpy of MOF A520 with regard to natural gas amounts to 17 kJ/mol. Further information on this type of MOF may be found in “Metal-Organic Frameworks, Wiley-VCH Verlag, David Farrusseng, 2011”. The pellets have all a cylindrical shape with a length of 3 mm and diameter of 3 mm. Their permeability is preferably between 1•10̂−15 m̂2 and 3•10̂−3 m̂2. The porosity of the bed, which is defined as the ratio of the void volume between the pellets to the total volume of the vessel without considering the free volume within the pellets, is at least 0.2, for example 0.35.

MOF Z377, in literature also referred to as MOF type 177, is based on zinc-benzene-tribenzoate. The specific surface area of a MOF Z377, measured by porosimetry or nitrogen adsorption, is typically in the range from 2000 m̂2/g to 5000 m̂2/g. The MOF Z377 typically posses an adsorption enthalpy between 12 kJ/mol and 17 kJ/mol with respect to natural gas. MOF C300 is based on copper benzene-1,3,5-tricarboxylate and for example commercially available from Sigma Aldrich under the tradename Basolite® C300.

Generally, a variety of materials can be applied and be combined for gas adsorbent media, independently of their characteristics regarding their impact on the gas flow in the vessel, their packing density and their heat capacity. The adsorbent media are preferably applied as pellets but can likewise be applied as powder, monolith or in any other form.

The porosity of the adsorbent medium is preferably at least 0.2. The porosity is defined here as the ratio of hollow space volume to total volume of any subvolume in the vessel of the sorption store. At a lower porosity, the pressure drop on flowing through the adsorbent medium increases, which has an adverse effect on the filling time, i.e. prolongs the filling time.

In a preferred embodiment of the invention, the adsorbent medium is present as a bed of pellets and the ratio of the permeability of the pellets to the smallest pellet diameter is at least between 1*ê−11 m̂2/m and 1*ê−16 m̂2/m, preferably between 1*ê−12 m̂2/m and 1*ê−14 m̂2/m, and most preferably 1*ê−13 m̂2/m. The rate at which the gas penetrates into the pellets during filling depends on the rapidity with which the pressure in the interior of the pellets becomes the same as the ambient pressure. With decreasing permeability and increasing diameter of the pellets, the time for this pressure equalization and thus also the loading time of the pellets increases. This can have a limiting effect on the overall process of filling and discharging of a sorption store.

The sorption store for storing the gaseous fuel can comprise a closed vessel. When gas is taken from the store, rapid and constant provision of gas has to be ensured. The sorption store can be equipped with a feed device which comprises at least one passage through the vessel wall through which a gas can flow into the vessel. The feed device can comprise, for example, an inlet and an outlet which can each be closed by means of a shutoff device.

The feed device can comprise means to vary the gas stream for example throttle valves or control valves, which can be located inside or outside of the vessel. The vessel can further comprise more than one passage through the vessel wall for example in order to lead the gas stream in optional subdepartments of the vessel or in order to provide separate passages for the filling and the discharge of the gas. Preferably, the same passage or the same passages are used for both, the discharge of the gas and the filling of the vessel.

Depending on the installation space available and the maximum permissible pressure in the vessel, different cross-sectional areas are suitable for the cylindrical vessel, for example circular, elliptical or rectangular. Irregularly shaped cross-sectional areas are also possible, e.g. when the vessel is to be fitted into a hollow space of a vehicle body. For high pressures above about 100 bar, circular and elliptical cross sections are particularly suitable. The vessel size vary according to the application. Diameters of the vessel of approximately 50 cm are typical for tanks in trucks and approximately 20 cm for tanks in cars, respectively. In cars fill volumes between 20 L and 40 L are provided whereas tanks of a volume between 500 L and 3000 L can be found in trucks.

In a further embodiment, the at least one vessel is substantially mounted horizontally. The vessel can be characterized by an elongated form and it can be installed in a horizontal position. Besides a vessel substantially horizontally mounted vessel, a vertical installation is likewise feasible. In a further embodiment, the vessel of the sorption store has a cylindrical shape and optionally a dividing element is arranged essentially coaxially to the cylinder axis.

The choice of the wall thickness of the vessel and of the dividing elements is dependent on the maximum pressure to be expected in the vessel, the dimensions of the vessel, in particular its diameter, and the properties of the material used. Materials for a vessel of sorption store are variable. Preferred materials are for example steel. In the case of an alloy steel vessel having an external diameter of 10 cm and a maximum pressure of 100 bar, for example, the minimum wall thickness has been estimated as 2 mm (in accordance with DIN 17458). The gap width of the double walls is selected so that a sufficiently large volume flow of the refrigerant can flow through them. It is preferably from 2 mm to 10 mm, particularly preferably from 3 mm to 6 mm.

In an embodiment of the invention, the at least one vessel is a pressure vessel for the storage of gas at a pressure in the range up to 500 bar, preferably in a range of 1 bar to 400 bar, most preferably in a range of 1 bar to 250 bar and in particular preferably in a range of 1 bar to 100 bar.

The vessel is usually cooled during filling and/or heated during discharging. As a result, larger amounts of gas can be adsorbed or desorbed in the same time.

An improvement in heat transfer can be achieved when not only the vessel wall but also optional at least one dividing element, or in the case of a plurality of dividing elements one or more thereof, are cooled or heated. For this purpose, the at least one dividing element or a plurality of dividing elements, in particular all dividing elements present, can be configured as double walls so that a refrigerant can flow through them.

A configuration with double-walled channel walls has the advantage that for switching from cooling to heating, it is merely necessary for the coolant to be changed or its temperature to be altered appropriately. Thus, this embodiment is, in mobile use, equally suitable for filling with fuel and for the traveling mode. A pump can convey the refrigerant in the cooling circuit. A pumping power of the pump can be varied as a function of a fill level of the sorption store.

Depending on the temperature range, which is appropriate for the cooling or heating of the gas in the sorption store, different heat carrier media may apply, for example water, glycol, alcohols or mixtures thereof. Corresponding heat carrier media are known by a person skilled in the art.

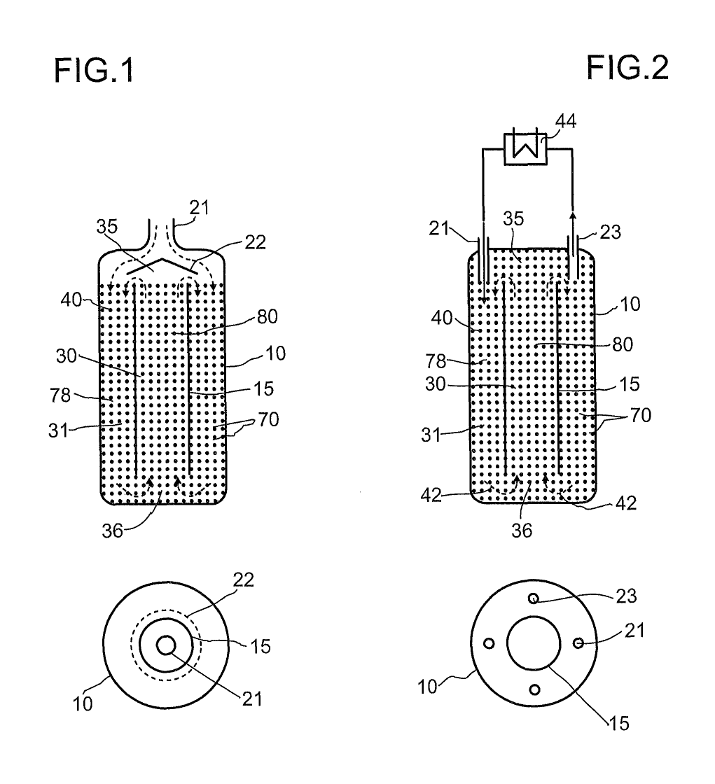

FIGS. 1 to 4 show schematical cross-sections of sorption stores according to the present invention. Said sorption stores 10 according to FIGS. 1 to 4 substantially have a cylindrical geometry 68. The upper figures show a longitudinal cross-section along the axes of the cylinder, whereas the lower figures show a cross-section perpendicular to the axes of the cylindrical sorption stores 10.

FIG. 1 shows a sorption store 10 according to the present invention having a surface wall 76, which is configured as a single wall.

According to FIG. 1, the sorption store 10 has a circular cross-section and comprises an inlet opening 21 on the upper end face thereof. Within an interior 78 of the sorption store 10 according to FIG. 1, at least one adsorbent medium 40 is filled, for example in the form of pellets 70. A porosity of the at least one adsorbent medium is defined by the ratio of hollow spaces between the pellets of the at least one adsorbent medium and the entire volume of the interior 78 of the sorption store 10 according to FIG. 1.

Reference numeral 22 depicts a deviation device. Below said deviation device 22 an upper common area 35 is established. The arrows given in FIG. 1 show a gas current which is established between the upper common area and a lower common area 36 in the interior 78 of the sorption store 10 according to FIG. 1. Reference numeral 80 depicts a center area of said sorption store 10. Pellets 70 of at least one adsorbent medium 40 are filled in the interior 78 of the sorption store's 10 first section 30, i.e. the center section of the sorption store 10 according to FIG. 1 is separated by means of the separating device 15 from a second section 31 at the periphery of the sorption store 10 according to FIG. 1.

The first separation device 15 may have a tubular shape corresponding co-axial to the central axis of the sorption store 10, which in general has a cylindrical geometry 68.

FIG. 2 shows a sorption store 10 according to the present invention arranged in vertical direction and having an active circulating cooling circuit integrated therein.

According to FIG. 2 at the inlet opening 21, the natural gas to be adsorbed by the at least one adsorbent medium 40 stored in the hollow interior 78 of said sorption store 10 is fed through the at least one adsorbent medium 40. Due to the force of density and/or gravity, the convection 42 indicated by said arrows at the bottom of said sorption store 10 is established and contributes to an even temperature distribution in the different sections 30, 31, respectively, of the interior 78 of said sorption store 10 according to FIG. 2. The natural gas is conducted through an outlet 23, led to a heat exchanger 44, where for example the heat generated by the reaction enthalpy of the gas to be adsorbed by the at least one adsorbent medium 40 is removed from the natural gas which in turn is—having a lower temperature—fed through the inlet opening 21 on the top end face of the sorption store 10 according to FIG. 2.

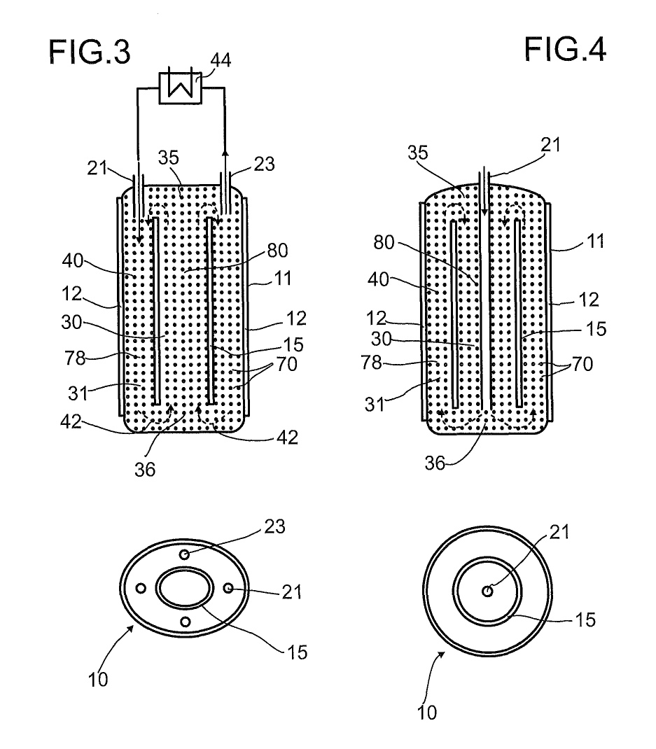

FIG. 3 shows a sorption store 10 according to the present invention in a substantially vertical orientation.

In the embodiment of the sorption store 10 according to FIG. 3, said sorption store 10 comprises a wall 11, which is embodied as a double-wall 12. Said double-wall 12 defines a hollow interior which may be cooled by a coolant to remove heat created for instance by the reaction enthalpy upon adsorption of the natural gas by the at least one adsorbent medium 40, particularly a metal-organic framework, such as A520, Z377 or C300, to mention but a few. By means of said double-wall 12, heat is removed from the periphery of the sorption store 10 according to the present invention created in the center area 80 of the sorption store, while said sorption store 10 is filled with natural gas to be adsorbed by the at least one adsorbent medium 40.

In the embodiment according to FIG. 3, a cooling of the sorption store 10 additionally is achieved by a heat exchanger 44, which cools the medium, i.e. the natural gas, entering the heat exchanger 44 via outlet opening 23, cooled in the heat exchanger 44 and being re-fed to the sorption store 10 according to the embodiment given in FIG. 3 via inlet opening 21.

By the circulation of the natural gas to be adsorbed on the at least one adsorbent medium 40, a convection 42 is created which contributes to a homogeneous temperature distribution within the interior 78 of the sorption store 10, comprising said at least one adsorbent medium 40. The current of gas is indicated by arrows in the upper common area 35 and the lower common area 36, respectively, of said sorption store 10 according to FIG. 3. Said sorption store 10 in the embodiment given in FIG. 3 has an elliptic cross-section but may be manufactured as well having a cylindrical geometry 68 similarly to the embodiment of the sorption store 10 given in FIGS. 1 and 2, respectively. In the embodiment according to FIG. 3, the separating element 15 is likewise double-walled, having an elliptic shape corresponding to the shape of the double-walled sorption store 10. The separating element 15 defines a center area 80 of the sorption store, where heat is generated upon adsorption of the natural gas to be adsorbed on the least one adsorbent medium 40, present there in the form of pellets 70, to give an example. Said pellets 70 may have a cylindrical, a rectangular, a triangular shape and create a porosity depending on the size and shape of the pellets 70 within the interior 78 of the sorption store 10.

FIG. 4 shows an embodiment of the sorption store 10, in which the inlet opening 21 is arranged in the center of the first section 30 of said sorption store 10. In this embodiment, the natural gas to be adsorbed is fed to the first section 30 of the sorption store 10, which is encapsulated by the first separating device 15, having substantially a tubular shape. By arrows, a gas current is indicated, which is induced in the sorption store 10 according to the embodiment given in FIG. 4, having substantially a cylindrical geometry 68.

In the embodiment given in FIG. 4, the heat is removed from the center area 80 by said double-walled separating element 15 and conducted to the outer periphery of the adsorption store which, similarly to the embodiment given in FIG. 3, has a double-wall 12 which may be additionally cooled by a coolant.

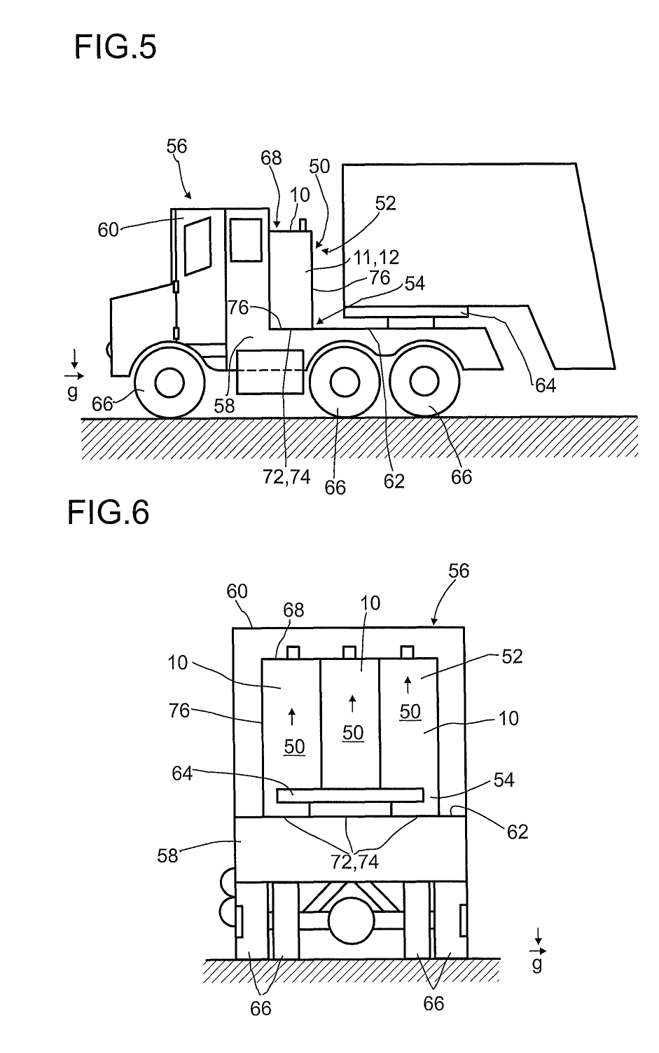

The sorption store 10, given in the FIGS. 1 to 4 have a substantially vertical orientation and may be arranged on a vehicle 56 as shown schematically in the following FIGS. 5, 6 and 7, respectively.

In FIG. 5, a vehicle 56 is shown, having a vehicle body 58. Said vehicle 56 comprises a passenger cabin 60 and a substantially horizontal plane 62 of the chassis of said vehicle 56. On the horizontal plane 62, a docking area 64 is established for a trailer to be coupled to the vehicle 56. Wheels of said vehicle 56 are indicated by reference numeral 66.

In the embodiment of the vehicle 56 according to FIG. 5, a number of sorption stores 10 is arranged in vertical position 50, i.e. in an upright position, on the horizontal plane 62. The number of sorption stores 10 arranged on the horizontal plane 62 of the vehicle 56 comprise an active cooling as described in FIGS. 1 to 4 and are additionally coupled via a connection 72, established by a surface contact 74 to the vehicle 56 or the vehicle body 58, respectively.

Consequently, heat generated by the reaction enthalpy upon filling of said sorption stores 10 is conducted via the intimate contact 72, i.e. the surface contact 74 of the wall 11 of the sorption stores 10 with the horizontal plane 62 of the vehicle 56. Thus, the vehicle 56 or the chassis 62 of the vehicle is used as a heat sink, i.e. the heat generated upon filling of the sorption stores 10 is conducted to the vehicle 56, thus, the sorption store is effectively cooled by means of the circulating system 42, 44 on the one hand side and on the other by means of the connection 72 between a bottom section 54 of said sorption store 10.

In FIG. 6, a rearward view of the vehicle 56 is given, on the top of the plane 62 arranged three sorption stores 10 having a cylindrical geometry 68, for instance. At the bottom section 54 of said sorption stores 10 mounted in substantially vertical position 50, said sorption stores 10 are in intimate contact 72 with the horizontal plane 62 of the vehicle 56. Thus, heat is conducted to the horizontal plane 62 and the cabin 60 of the vehicle 56, i.e. the vehicle 56 is used as a heat sink to which the heat generated in sorption store 10 is conducted. By means of the intimate contact 72 of the wall surface 74 with the horizontal plane 62 of the vehicle 56, the heat generated in the sorption store 10 is conducted to the vehicle 56. Further, said sorption store 10 mounted on the vehicle 56 has an active circulating cooling comprising a heat exchanger 44 which cools the natural gas during the filling operation of the sorption store 10. Heat is removed from the circulating natural gas by the heat exchanger 44 and may be used for other purposes. Additionally, the sorption store 10 may have, as indicated in FIGS. 3 and 4, respectively, a double-wall 12 which is cooled as well, so that the periphery of the sorption store 10 according to the present invention, serves as a third cooling mean.

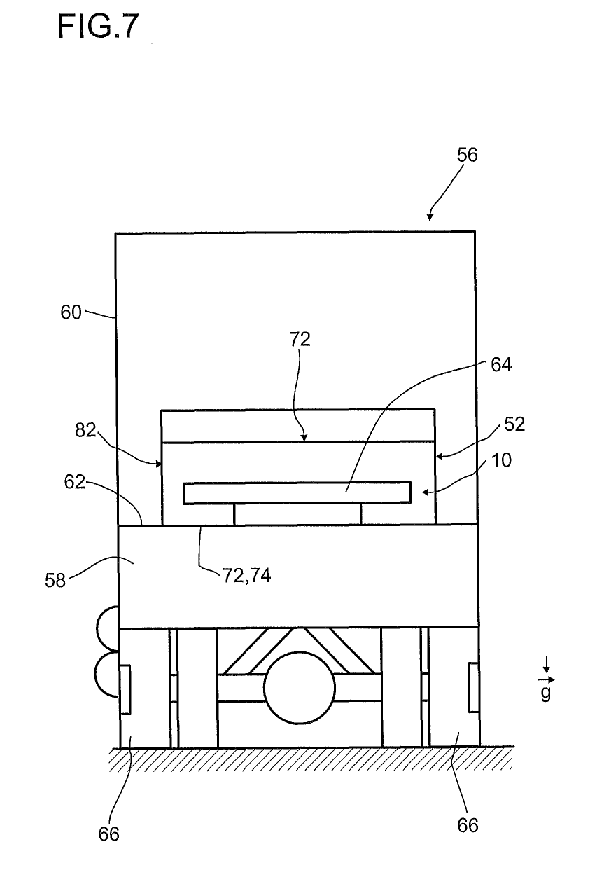

In FIG. 7, the sorption store 10 according to the present invention is mounted in a substantially horizontal position 82.

Reference numeral 82 depicts a horizontal position of the sorption store 10 according to the embodiment in FIG. 7. In this embodiment, the sorption store is mounted on the horizontal plane 62 of the vehicle 56 behind said cabin 60. In the horizontal position 82 of the sorption store 10 according to the embodiment given in FIG. 7, likewise an intimate contact 72, 74 is established with the outer wall 11 of the sorption store 10 and the horizontal plane 62 of the vehicle 56. Additionally, the upper part 52 of the sorption store 10 arranged in horizontal position 82 is covered by a part of the vehicle 56, i.e. by the rear-side wall of the cabin 60 of the vehicle 56. A very effective cooling is achieved in respect to heat conduction, if ⅛ to ⅔ of the surface wall 76 of the sorption store 10 are in contact 72 with the vehicle 56 or parts thereof, such as the cabin 60 or the horizontal plane 62 to mention but a few. Additionally, if the intimate contact 72, 74 is established in the upper part 52 of the sorption store 10, given the horizontal orientation 82 thereof on the vehicle 56, a very effective cooling is established in those areas of the sorption store 10, in which higher temperatures occur.

An even or more homogeneous temperature distribution within the sorption store 10 is achieved, if a gas current system due to gravity differences of the natural gas to be adsorbed is induced as well as a gas current system which is driven by forces resulting from different densities of the natural gas to be adsorbed. In both cases, an eddy-system is induced in the interior 78 of the sorption store 10 according to the present invention, which significantly contributes to the homogeneous temperature distribution within the interior 78 of the sorption store 10 according to the present invention.

### LIST OF REFERENCE NUMERALS

10 Sorption store

11 Wall

12 Double wall

15 First separating device

21 Inlet opening

22 Deviation device

23 Outlet opening

30 First section

31 Second section

35 Upper common area

36 Lower common area

40 Adsorbent medium

42 Convection

44 Heat exchanger

50 Vertical position of sorption store 10

52 Top section, upper part

54 Bottom section, lower part

56 Vehicle

58 Vehicle's body

60 Cabin

62 Horizontal plane of chassis

64 Docking area

66 Wheel (base)

68 Cylindrical geometry

70 Pellets of adsorbent medium 40

72 Connection for heat conduction

74 Surface contact

76 Surface wall

78 Interior of sorption store 10

80 Center area

82 Horizontal position of sorption store 10

1.-15. (canceled)

16. A sorption store for storing an adsorbed natural gas, said sorption store containing at least one adsorbent medium, wherein said sorption store is equipped with an external passive cooling, further comprising an active circulating cooling system, by means of which in an interior of said sorption store a gas current due to density differences of the gas to be absorbed is induced.

17. The sorption store according to claim 16, wherein said external passive cooling is a connection of said sorption store to a vehicle or a vehicle's body, respectively.

18. The sorption store according to claim 17, wherein said connection of said sorption store to said vehicle or vehicle's body is a surface contact between said sorption store and said vehicle or said vehicle's body, respectively.

19. The sorption store according to claim 16, wherein ⅛ up to ⅔ of the surface wall of the sorption store is in contact with a vehicle or said vehicle's body.

20. The sorption store according to claim 17, wherein the sorption store is horizontally mounted and is connected with its upper part to the vehicle or the vehicle's body.

21. The sorption store according to claim 16, wherein the temperature of the surface wall of said sorption store is constant during a filling operation thereof.

22. The sorption store according to claim 16, wherein said surface wall is a double wall at least in those areas of the sorption store which are not in contact with the vehicle or the vehicle's body.

23. The sorption store according to claim 16, wherein in an interior of said sorption store a gas current due to gravity differences is induced.

24. The sorption store according to claim 16, wherein a homogeneous temperature distribution is established in the sorption store.

25. The sorption store according to claim 17, wherein the vehicle or the vehicle's body itself is a heat-providing heat source or a heat-receiving heat storage means.

26. A method for reducing a filling time of the sorption store according to claim 16 with an adsorbed natural gas (ANG), comprising:
a) filling a natural gas to be absorbed by at least one adsorbent medium within the sorption store,
b) active cooling of an interior of the sorption store via a cooling and circulation system,
c) passive cooling of a surface wall of the sorption store by heat conduction to a vehicle and
d) creating a homogeneous temperature distribution by inducing at least one gas-eddy-system in the interior due to gravity and/or density differences of the adsorbed natural gas (ANG).

27. The method according to claim 26, wherein according to method step b), a center area of said sorption store is cooled actively to enhance adsorption capacity of the at least one adsorbent medium.

28. The method according to claim 26, wherein a surface temperature of the surface wall of the sorption store is maintained constant upon a filling operation of said sorption store.
